(19) United States
(12) Patent Application Publication
(10) Pub. No.: US 2022/0356052 A1
(43) Pub. Date: Nov. 10, 2022

(54) SYSTEM AND METHOD FOR REMOTELY CONTROLLING VEHICLE

(71) Applicants: Hyundai Motor Company, Seoul (KR); Kia Corporation, Seoul (KR)

(72) Inventor: Dong Hyuk Kim, Hanam-si (KR)

(73) Assignees: Hyundai Motor Company, Seoul (KR); Kia Corporation, Seoul (KR)

(21) Appl. No.: 17/495,578

(22) Filed: Oct. 6, 2021

(30) Foreign Application Priority Data
May 7, 2021 (KR) 10-2021-0059368

(51) Int. Cl. B66F 9/075; B66F 9/22; G05D 1/00

(52) U.S. Cl. CPC B66F 9/07581; B66F 9/22; G05D 1/0061; G05D 1/0011; G05D 2201/0202

(57) ABSTRACT

A system and a method for remotely controlling a vehicle for safe loading and unloading of cargo, may include a vehicle, and a remote control device that performs data communication with the vehicle control device of the vehicle, and the vehicle sends a request to the remote control device for remote control when arriving at a destination, moves to a work location and performs work under control of the remote control device, requests the remote control device to deactivate the remote control when the work is completed, and performs exit of the destination through autonomous driving of the vehicle.

### CROSS-REFERENCE TO RELATED APPLICATION

The present application claims priority to Korean Patent Application No. 10-2021-0059368, filed on May 7, 2021, the entire contents of which is incorporated herein for all purposes by this reference.

### BACKGROUND OF THE INVENTION

### Field of the Invention

The present invention relates to a system and a method for remotely controlling a vehicle for safe loading and unloading of cargo.

### Description of Related art

A construction vehicle is a construction machine used in civil works or construction sites, and includes a dump truck, a bulldozer, a crane, and the like. Such construction vehicle operates based on manipulation of an operator in a cab. However, recently, with a development of a control technology and a sensing technology, research on a construction vehicle which may work by itself without operator boarding has been conducted. An unmanned construction vehicle (i.e., an autonomous driving construction vehicle) performs a provided work by recognizing a workspace using sensors mounted on a vehicle body and controlling a behavior thereof based on the recognized information. Because such unmanned construction vehicle performs a predetermined operation, when performing an unplanned work, for example, loading and unloading of a load, at the construction site, it may be difficult to respond, and a rollover accident or the like may occur in a process of unloading the load.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system and a method for remotely controlling a vehicle that remotely control the vehicle when arriving at a construction site for safe loading and unloading of cargo.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, a system for remotely controlling a vehicle includes the vehicle having a vehicle control device, and a remote control device that performs data communication with the vehicle control device of the vehicle, and the vehicle control device sends a request to the remote control device configured for remote control when arriving at a destination, moves to a work location and performs work under control of the remote control device, requests the remote control device to deactivate the remote control when the work is completed, and performs exit of the destination through autonomous driving of the vehicle.

In various exemplary embodiments of the present invention, the remote control device may activate a remote control function of the vehicle in a response to the request to the remote control of the vehicle.

In various exemplary embodiments of the present invention, the vehicle control device of the vehicle may switch a control mode of the vehicle from an autonomous control mode to a remote control mode, and display state information indicating that the vehicle is operating in the remote control mode on a front surface of the vehicle.

In various exemplary embodiments of the present invention, the vehicle control device of the vehicle may send a request to the remote control device for destination entry in the remote control mode, and the remote control device may send a request to a management device for entry approval to the destination in a response to the request of the vehicle.

In various exemplary embodiments of the present invention, the management device may determine to approve or reject the destination entry of the vehicle according to the state information displayed on the front surface of the vehicle.

In various exemplary embodiments of the present invention, the vehicle may send a request to the remote control device for work approval when arriving at the work location, and control a hydraulic device of the vehicle to perform the work when receiving a work approval result from the remote control device.

In various exemplary embodiments of the present invention, the vehicle may stop the work when receiving a work stop command from the remote control device while performing the work.

In various exemplary embodiments of the present invention, the vehicle control device of the vehicle may send a request to the remote control device for remote control deactivation when the vehicle arrives at a destination exit location, and the remote control device may deactivate a remote control function of the vehicle in a response to the request of the remote control deactivation.

In various exemplary embodiments of the present invention, the vehicle control device of the vehicle may switch a control mode from a remote control mode of the vehicle to an autonomous control mode when the remote control function is deactivated, send a request to the remote control device for destination exit, and exit the destination in the autonomous control mode when receiving a destination exit approval from the remote control device.

According to various aspects of the present invention, a method remotely controlling a vehicle includes sending, by the vehicle, a request to a remote control device for remote control after arriving at a destination, performing, by the vehicle, work after moving to a work location under control of the remote control device, requesting, by the vehicle, the remote control device to deactivate the remote control when the work is completed, and performing, by the vehicle, exit of the destination through autonomous driving of the vehicle.

In various exemplary embodiments of the present invention, the sending the request to the remote control may include switching a control mode of the vehicle from an autonomous control mode to a remote control mode when the vehicle arrives at the destination, and activating, by the remote control device, a remote control function of the vehicle in a response to the request to the remote control of the vehicle.

In various exemplary embodiments of the present invention, the sending the request to the remote control may further include displaying, by the vehicle, state information indicating that the vehicle is operating in the remote control mode on a front surface of the vehicle.

In various exemplary embodiments of the present invention, the sending the request to the remote control may further include sending, by the vehicle, a request to the remote control device for destination entry, sending, by the remote control device, a request to a management device for destination entry approval, and transmitting, by the remote control device, an entry approval response of the management device to the vehicle.

In various exemplary embodiments of the present invention, the sending the request to the remote control may further include determining, by the management device, to approve or reject the entry according to the state information displayed on the front surface of the vehicle.

In various exemplary embodiments of the present invention, the performing of the work may include performing, by the vehicle, the moving of the vehicle to the work location provided from the remote control device, sending, by the vehicle, a request to the remote control device for work approval when arriving at the work location, and controlling, by the vehicle, a hydraulic device to perform the work based on a result of the work approval received from the remote control device.

In various exemplary embodiments of the present invention, the method may further include receiving, by the vehicle, a work stop command from the remote control device while performing the work, and stopping, by the vehicle, the work in a response to the work stop command.

In various exemplary embodiments of the present invention, the requesting to deactivate the remote control may include deactivating, by the remote control device, a remote control function in a response to the request of the vehicle, and switching, by the vehicle, a control mode from a remote control mode to an autonomous control mode.

In various exemplary embodiments of the present invention, the performing of the exit of the destination may include sending, by the vehicle, a request to the remote control device for destination exit, and exiting the destination in the autonomous control mode when receiving a destination exit approval from the remote control device.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration showing a vehicle remote control system according to exemplary embodiments of the present invention;

FIG. 2 is a block diagram showing a vehicle control device according to exemplary embodiments of the present invention;

FIG. 3A and FIG. 3B are exemplary diagrams for displaying vehicle state information according to exemplary embodiments of the present invention;

FIG. 4 is a flowchart illustrating a vehicle construction site entry and exit remote control method according to various exemplary embodiments of the present invention;

FIG. 5 is a flowchart illustrating a vehicle remote control method according to various exemplary embodiments of the present invention; and

FIG. 6 is a block diagram illustrating a computing system according to exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of the related known configuration or function will be omitted when it is determined that it interferes with the understanding of the exemplary embodiment of the present invention.

In describing the components of the exemplary embodiment according to various exemplary embodiments of the present invention, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein.

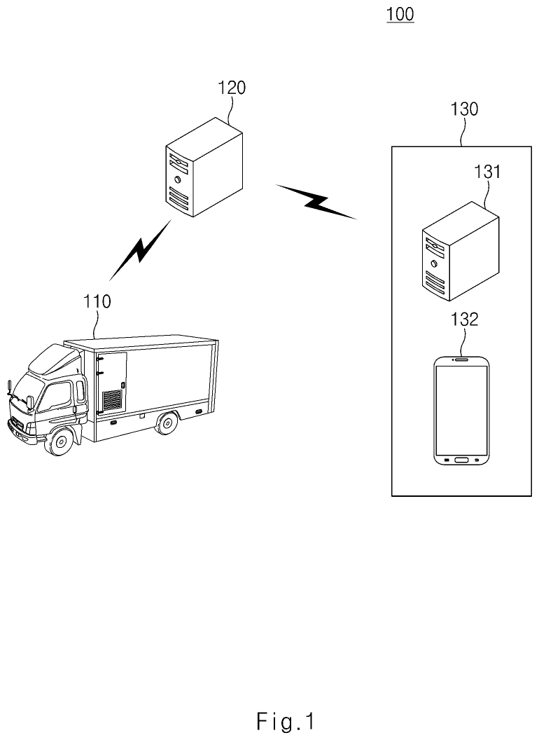

FIG. 1 is a configuration showing a vehicle remote control system according to exemplary embodiments of the present invention.

Referring to FIG. 1, a vehicle remote control system 100 may include a vehicle 110, a remote control device 120, and/or a management device 130.

The vehicle 110 may be a construction vehicle used in a construction site, for example, a dump truck and/or a forklift. Furthermore, the vehicle 110 may be a distribution vehicle that transports goods. The vehicle 110 may be provided with an autonomous driving function. The vehicle 110 may recognize a surrounding environment using sensors mounted on a vehicle body. The vehicle 110 may perform autonomous driving by controlling a vehicle behavior based on the recognized surrounding environment.

Furthermore, the vehicle 110 may send a request to a control center for a remote control when arriving at the construction site. Thereafter, the vehicle 110 may control the vehicle behavior based on a control command transmitted from the remote control device 120 of the control center. The vehicle 110 may transmit vehicle state information and/or image information to the remote control device 120. The vehicle 110 may control the vehicle behavior based on the control command of the remote control device 120 and move to a work location to perform a provided work (e.g., dumping).

The remote control device 120 may exchange data (information) with the vehicle 110 using wireless communication. The remote control device 120 may remotely control a behavior (an operation) of the vehicle 110 based on the information provided from the vehicle 110. The remote control device 120 may activate or deactivate a remote control function of the vehicle in a response to a request of the vehicle 110. The remote control device 120 may send a request to the management device 130 for approval for construction site entry and exit of the vehicle 110 in a response to a request of the vehicle 110. Furthermore, the remote control device 120 may share the work location, for example, information on a location of a load loading and unloading site with the vehicle 110. The remote control device 120 may send a request to the management device 130 for approval for the work of the vehicle 110 when the vehicle 110 arrives at the work location.

The management device 130 may manage the vehicle 110 entering and exiting the construction site. When receiving the request for approval for the entry of the vehicle 110 or the request for approval for the exit of the vehicle 110 from the remote control device 120, the management device 130 may determine approval or rejection for the corresponding approval request. The management device 130 may transmit a response indicating the approval or the rejection to the remote control device 120 depending on whether to approve. The management device 130 may determine the entry and the exit of the vehicle 110 by searching an entry and exit permission management DB (database) based on identification information of the vehicle 110.

Furthermore, the management device 130 may recognize a vehicle state by identifying a mark displayed on a windshield mounted on a front surface of the vehicle 110. The management device 130 may determine whether to approve based on the recognized vehicle state. When the vehicle 110 is located at an entrance to the construction site and is in a remote control state, the management device 130 may permit (approve) the entry. When the vehicle 110 is located at an exit of the construction site and is in an autonomous control state, the management device 130 may permit (approve) the exit.

The management device 130, which is an electronic device operated by a field manager and/or a work manager, may be a fixed terminal 131, and/or a mobile terminal 132, and the like. The management device 130 may manage the work, for example, the loading and the unloading of cargo (the load), of the vehicle 110 located in the construction site. The management device 130 may manage a work location and/or a work type for each vehicle in a form of a DB. The management device 130 may receive the request for the approval for the work (a cargo loading or unloading approval request) of the vehicle 110 from the remote control device 120. The management device 130 may determine whether to approve the work of the vehicle 110 by referring to a work management DB for each vehicle. The management device 130 may transmit a response indicating approval or rejection for the work approval request to the remote control device 120.

Furthermore, the management device 130 may transmit a work stop request to the remote control device 120 in a response to an input of the manager. The manager may request the remote control device 120 of the control center to stop the work when a dangerous situation occurs by monitoring the state of the vehicle 110. The remote control device 120 may notify a driver who drives the vehicle 110 remotely of the dangerous situation, and may request (instruct) the vehicle 110 to stop the work in a response to an instruction of the remote driver.

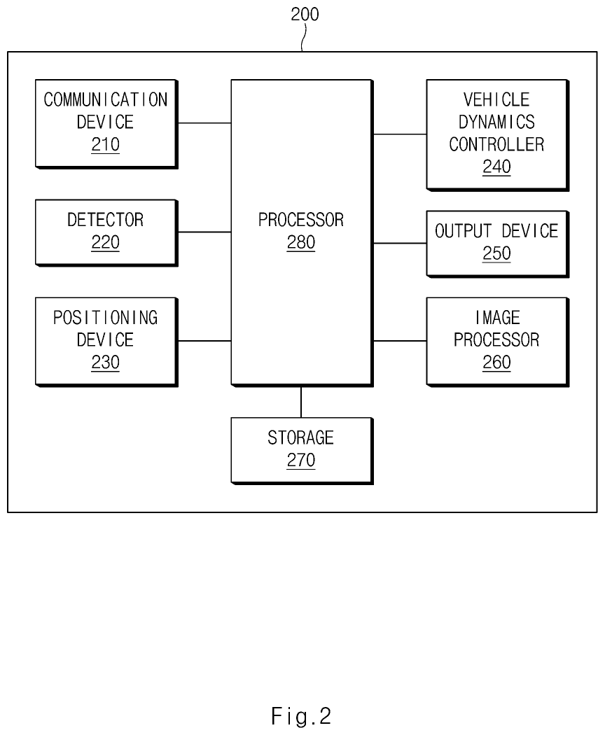

FIG. 2 is a block diagram showing a vehicle control device according to exemplary embodiments of the present invention.

A vehicle control device 200 may be mounted on the vehicle 110 to control travel and the work (e.g., the loading and the unloading of the load). Referring to FIG. 2, the vehicle control device 200 may include a communication device 210, a detector 220, a positioning device 230, a vehicle dynamics controller 240, an output device 250, an image processor 260, storage 270, and/or a processor 280.

The communication device 210 may support the vehicle 110 to perform wired or wireless communication with an external device (e.g., the remote control device 120 and/or the management device 130). The communication device 210 may include a wireless communication circuit (e.g., a cellular communication circuit, a short-range wireless communication circuit, or a global navigation satellite system (GNSS) communication circuit), and/or a wired communication circuit (e.g., a local area network (LAN) communication circuit or a power line communication circuit). The communication device 210 may communicate with the external device using one of the wireless communication circuit and the wired communication circuit.

The detector 220 may detect information such as the surrounding environment and/or a driver state through various sensors mounted on the vehicle 110. The detector 220 may include a radio detecting and ranging (RADAR), a light detection and ranging (LiDAR), a high-resolution LiDAR, an ultrasonic sensor, and/or a camera (an image sensor). For example, the detector 220 may detect (recognize) the surrounding environment of the vehicle 110 using at least one of a front radar, a side radar, a front LiDAR, a side LiDAR, a front camera, a side camera, and/or a rear camera.

Furthermore, the detector 220 may sense the occurrence of the dangerous situation based on sensing data measured by the sensors. The detector 220 may transmit a signal notifying the occurrence of the dangerous situation to the processor 280.

The positioning device 230 may measure (determine) a current location of the vehicle 110. The positioning device 230 may measure the vehicle location using at least one of positioning technologies such as a global positioning system (GPS), a dead reckoning (DR), a differential GPS (DGPS), a carrier phase differential GPS (CDGPS), and the like.

The vehicle dynamics controller 240 may control acceleration, deceleration, steering, and/or braking of the vehicle 110. The vehicle dynamics controller 240 may include a driving device, a steering device, and/or a braking device. The driving device, which controls driving of the vehicle 110, may transmit power generated from a power source (e.g., an engine or a motor) to a wheel. The driving device may be implemented as an engine management system (EMS), a traction control system (TCS), and/or an all wheel drive system (AWD). The steering device may change a traveling direction of the traveling vehicle 110. The steering device may be implemented as a four wheel steering system (4WS), an electric power steering (EPS), an active front steering (AFS), and/or a steer-by-wire (SBW). The braking device may decelerate or stop the vehicle 110. The braking device may include an anti-lock braking system (ABS), an electronic stability control (ESC), and/or an electronic parking brake (EPB) system.

The vehicle dynamics controller 240 may control a hydraulic device mounted on the vehicle 110 to operate mechanical portions. The mechanical portions, which are for performing a main function of the vehicle 110, may be a dump body of the dump truck, a bucket of an excavator, and the like. For example, the vehicle dynamics controller 240 may control the hydraulic device to adjust elevation, lowering, and/or inclination of a dump body provided in the vehicle 110.

The output device 250 may output visual information and/or auditory information. The output device 250 may output information indicating a control state and/or an operating state (e.g., being in communication connection) of the vehicle 110. The control state may be classified into the autonomous control state, the remote control state, and/or a manual control state. The output device 250 may include a light emitting device, a display, a speaker, and the like. For example, the output device 250 may change a color displayed on a windshield edge portion of the vehicle 110 based on the control state of the vehicle 110.

The image processor 260 may acquire (shoot) an image of a surrounding region of the vehicle 110 using at least one camera. The image processor 260 may perform image processing such as noise removal, color reproduction, file compression, image quality adjustment, and saturation adjustment on the acquired image. The image processor 260 may deliver the image-processed image of the surrounding region to the communication device 210. The communication device 210 may transmit the image of the surrounding region to the remote control device 120 and/or the management device 130.

The storage 270 may include an autonomous control algorithm, a remote control algorithm, a mechanical portion control algorithm, map data, and/or setting information. The storage 270 may be a non-transitory storage medium that stores instructions executed by the processor 280. The storage 270 may be implemented as at least one of storage media (recording media) of a flash memory, a hard disk, a solid state disk (SSD), a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, and the like.

The processor 280 may execute the instructions and/or the algorithm stored in the storage 270. The processor 280 may be implemented as at least one of processing devices of an application specific integrated circuit (ASIC), a digital signal processor (DSP), a programmable logic device (PLD), a field programmable gate array (FPGA), a central processing unit (CPU), a microcontroller, and/or a microprocessor.

The processor 280 may set the control mode of the vehicle 110 in a response to an input received from a user or the remote control device 120. The processor 280 may set the control mode of the vehicle 110 to an autonomous control mode, a remote control mode, or a manual control mode.

When receiving a destination (e.g., the construction site and a work site) from the remote control device 120 in the autonomous control mode, the processor 280 may set the received destination as a destination. The processor 280 may search for a route to the set destination, and control the autonomous driving of the vehicle 110 along the searched route. The processor 280 controls the vehicle dynamics controller 240 based on the surrounding environment detected by the detector 220, so that the processor 280 may control the behavior (e.g., the acceleration, the deceleration, the steering, and/or the braking) of the vehicle 110.

The processor 280 may determine whether the vehicle 110 has arrived at the destination. The processor 280 may compare the vehicle location measured by the positioning device 230 with a destination location to determine whether the vehicle 110 has arrived at the destination.

The processor 280 may send a request to the remote control device 120 for the remote control when arriving at the destination. Furthermore, the processor 280 may request the remote control and activate the remote control mode. That is, the processor 280 may switch the control mode of the vehicle 110 from the autonomous control mode to the remote control mode. The processor 280 may receive a response to the remote control request from the remote control device 120. The processor 280 may complete the activation of the remote control mode when receiving an affirmative response from the remote control device 120.

The processor 280 may display (output) visual information (a mark) indicating that the vehicle 110 is in the remote control state after activating the remote control mode. The processor 280 may request entry to the destination. The processor 280 may receive an entry approval (permission) response to the destination entry request. When receiving the entry approval response, the processor 280 may control the vehicle 110 in a response to a control command transmitted from the remote control device 120.

The processor 280 may control the travel of the vehicle 110 to the cargo loading and unloading site in a response to a control command transmitted from the remote control device 120. In the present connection, the processor 280 may receive the information on the location of the cargo loading and unloading site from the remote control device 120. When the vehicle 110 arrives at the cargo loading and unloading site, the processor 280 may send a request to the remote control device 120 for the loading and the unloading of the cargo. When receiving a cargo loading and unloading approval response as a result of the cargo loading and unloading request from the remote control device 120, the processor 280 may control the hydraulic device to perform the cargo loading and unloading work of the vehicle 110.

The processor 280 may stop the cargo loading and unloading work when receiving a cargo loading and unloading stop command from the remote control device 120 while performing the cargo loading and unloading work. Furthermore, the processor 280 may terminate the cargo loading and unloading work when the cargo loading and unloading work is completed.

The processor 280 may control the travel of the vehicle 110 to a destination exit location after terminating the cargo loading and unloading work. When the vehicle 110 arrives at the destination exit location, the processor 280 may transmit a remote control deactivation request to the remote control device 120.

The processor 280 may switch the control mode of the vehicle 110 from the remote control mode to the autonomous control mode after requesting the remote control deactivation. The processor 280 may output visual information indicating that the vehicle 110 is in the autonomous control state on the output device 250 after activating the autonomous control mode.

The processor 280 may transmit a destination exit request to the remote control device 120. When receiving an approval response for the exit request from the remote control device 120, the processor 280 may perform destination exit of the vehicle 110 in the autonomous control mode.

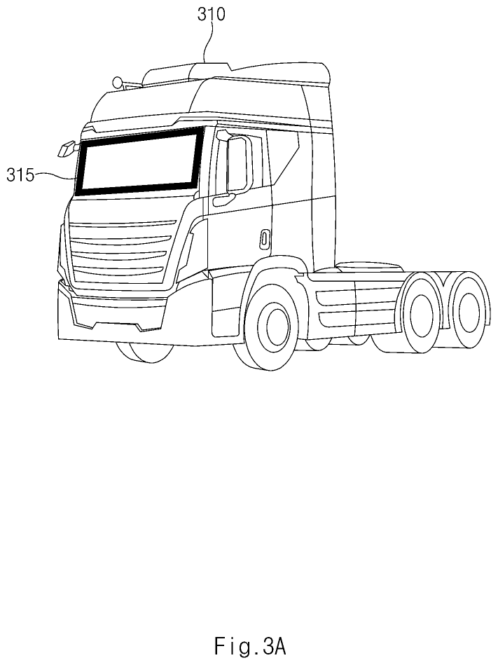

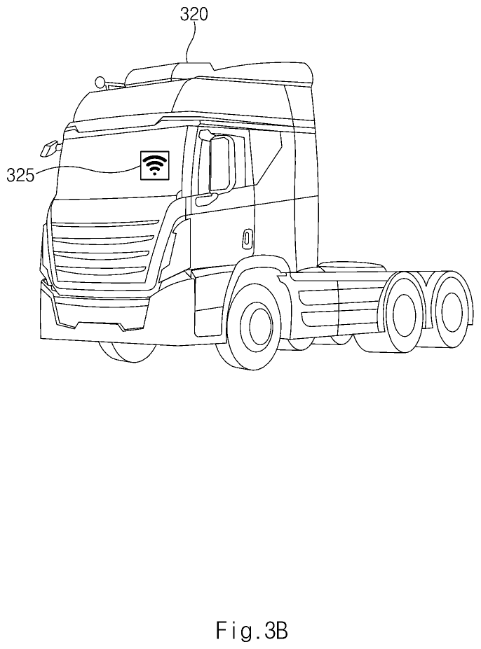

FIG. 3A and FIG. 3B are exemplary diagrams for displaying vehicle state information according to exemplary embodiments of the present invention.

Referring to FIG. 3A, a vehicle 310 may change an edge color of a windshield 315 based on the control state. The vehicle 310 may change the edge color of the windshield 315 to blue when the control state is the autonomous control state. Furthermore, the vehicle 310 may change the edge color of the windshield 315 to red when the control state is switched from the autonomous control state to the remote control state.

Referring to FIG. 3B, a vehicle 320 may display a mark 325 indicating the operating state on the windshield. A symbol, an icon, and/or an image may be used as the mark 325. For example, when the operating state of the vehicle 320 is the ‘being in communication connection’, the vehicle 320 may display an icon indicating this on the windshield.

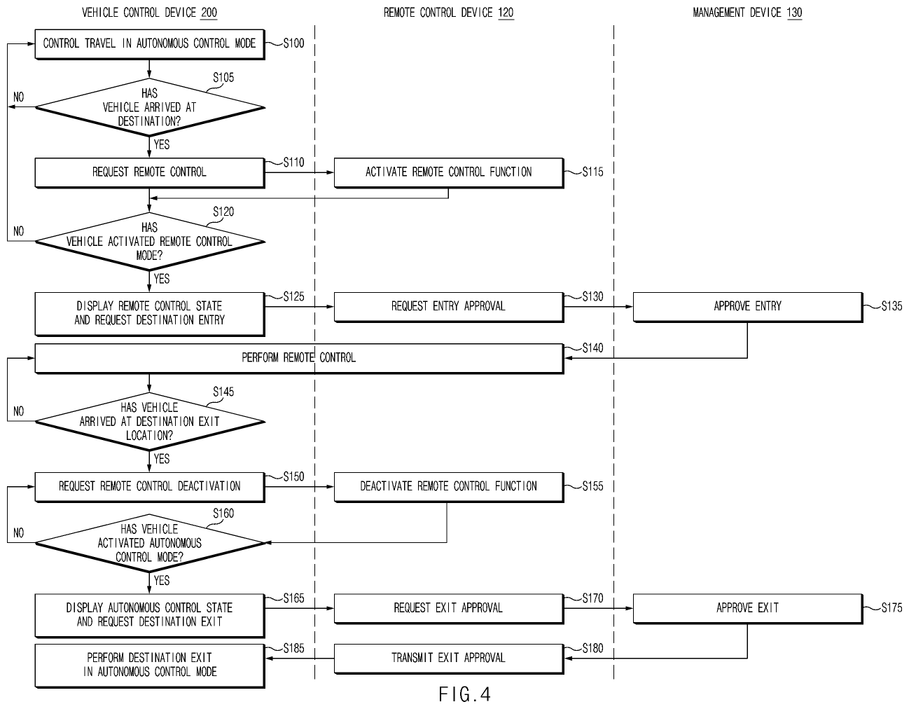

FIG. 4 is a flowchart illustrating a vehicle construction site entry and exit remote control method according to various exemplary embodiments of the present invention. The exemplary embodiment will be described with an example in which the construction site entry and exit of the vehicle is remotely controlled.

The vehicle control device 200 of the vehicle 110 may control the travel in the autonomous control mode (S100). The vehicle control device 200 may receive the destination (e.g., the construction site) from the driver or the remote control device 120. The vehicle control device 200 may set the received destination as the destination and search for the route to the destination. The vehicle control device 200 may control the autonomous driving of the vehicle 110 along the searched route.

The vehicle control device 200 may determine whether the vehicle 110 has arrived at the destination (S105). The vehicle control device 200 may determine the current location of the vehicle 110 through the positioning device 230. The vehicle control device 200 may compare the current location of the vehicle 110 with the location of the destination set as the destination to determine whether the vehicle 110 has arrived at the destination.

The vehicle control device 200 may send a request to the remote control device 120 for the remote control when arriving at the destination (S110). When the vehicle 110 arrives at the entrance of the destination, the vehicle control device 200 may transmit a remote control request message to the remote control device 120. When transmitting the remote control request message, the vehicle control device 200 may transmit the identification information (e.g., a vehicle identification number) and the like of the vehicle 110 together.

The remote control device 120 may activate a remote control function when receiving the remote control request from the vehicle control device 200 (S115). When receiving the remote control request message, the remote control device 120 may determine whether the remote control is possible using the identification information of the vehicle 110 contained in the remote control request message. When the remote control of the vehicle 110 is possible, the remote control device 120 may execute the remote control function and transmit a response message for accepting the remote control request to the vehicle 110.

The vehicle control device 200 may determine whether the vehicle 110 has activated the remote control mode (S120). The vehicle control device 200 may receive the response message for accepting the remote control request from the remote control device 120. The vehicle control device 200 may determine whether the control mode of the vehicle 110 is switched from the autonomous control mode to the remote control mode. When the vehicle control device 200 receives the acceptance message for the remote control request and the control mode is switched to the remote control mode, the vehicle control device 200 may determine that the remote control mode activation is complete.

The vehicle control device 200 may display that the vehicle is in the remote control state after activating the remote control mode and send a request to the remote control device 120 for the destination entry (S125). The vehicle control device 200 may change the edge color of the windshield based on the control state of the vehicle 110. For example, the vehicle control device 200 may change the edge color of the windshield to the blue when the vehicle 110 is the autonomous control state, and change the edge color of the windshield to the red when the vehicle 110 is in the remote control state. The vehicle control device 200 may transmit a request message requesting permission to the destination entry of the vehicle 110 to the remote control device 120. The request message may include the identification information and/or pass information of the vehicle 110.

The remote control device 120 may send a request to the management device 130 for the entry approval of the vehicle 110 when receiving the destination entry request (S130). The remote control device 120 may transmit the request message for requesting the destination entry approval (permission) of the vehicle 110 to the management device 130.

The management device 130 may approve the entry of the vehicle 110 based on the request of the remote control device 120 (S135). The management device 130 may transmit an entry approval result to the remote control device 120 as a response message.

When the entry of the vehicle 110 is approved, the remote control device 120 may perform the remote control of the vehicle 110 through communication with the vehicle control device 200 (S140). The vehicle control device 200 may transmit the information on the surrounding environment sensed using the detector 220 to the remote control device 120. The vehicle control device 200 may transmit information such as the vehicle location determined using the positioning device 230, the image of the surrounding region processed by the image processor 260, and the like to the remote control device 120. The remote control device 120 may control the vehicle 110 based on at least one of the information of the surrounding environment information, the vehicle location, the image of the surrounding region, and the like provided from the vehicle control device 200. The remote control device 120 may transmit a control command for controlling the vehicle 110 to the vehicle control device 200, and the vehicle control device 200 may perform the travel and the work of the vehicle 110 by controlling the vehicle dynamics controller 240 in a response to the control command transmitted from the remote control device 120.

The vehicle control device 200 may determine whether the vehicle 110 has arrived at the exit location of the destination (S145). The vehicle control device 200 may determine whether the vehicle 110 has arrived at the exit location based on the vehicle location measured by the positioning device 230.

The vehicle control device 200 may request the remote control device 120 to deactivate the remote control when the vehicle 110 arrives at the exit location of the destination (S150). The vehicle control device 200 may transmit a remote control deactivation request message for requesting stopping of the remote control of the vehicle 110 to the remote control device 120.

The remote control device 120 may deactivate the remote control function in a response to the request message of the vehicle control device 200 (S155). The remote control device 120 may transmit a response message indicating that the remote control function is deactivated to the vehicle control device 200 after the remote control function is deactivated.

When the remote control function of the remote control device 120 is deactivated, the vehicle control device 200 may determine to activate the autonomous control mode (S160). The vehicle control device 200 may switch the control mode from the remote control mode to the autonomous control mode.

The vehicle control device 200 may display that the vehicle is in the autonomous control state after activating the autonomous control mode and send a request to the remote control device 120 for the destination exit (S165). The vehicle control device 200 may display (output) a mark indicating that the vehicle 110 is operating in the autonomous control mode on the windshield. Furthermore, the vehicle control device 200 may transmit an exit request message requesting the destination exit of the vehicle 110 to the remote control device 120.

The remote control device 120 may send a request to the management device 130 for exit approval in a response to the request of the vehicle control device 200 (S170). The remote control device 120 may transmit an exit approval request message requesting permission for the destination exit of the vehicle 110 to the management device 130.

The management device 130 may approve the destination exit of the vehicle 110 in a response to the request of the remote control device 120 (S175). The management device 130 may transmit a response message notifying the destination exit approval of the vehicle 110 to the remote control device 120.

The remote control device 120 may transmit the exit approval to the vehicle control device 200 based on the response of the management device 130 (S180). The remote control device 120 may transmit the response message for approving the destination exit of the vehicle 110 to the vehicle control device 200 in a response to the request of the vehicle control device 200.

The vehicle control device 200 may perform the destination exit of the vehicle 110 in the autonomous control mode based on the exit approval (S185). The vehicle control device 200 may control the autonomous driving of the vehicle 110 by setting a new destination outside the destination.

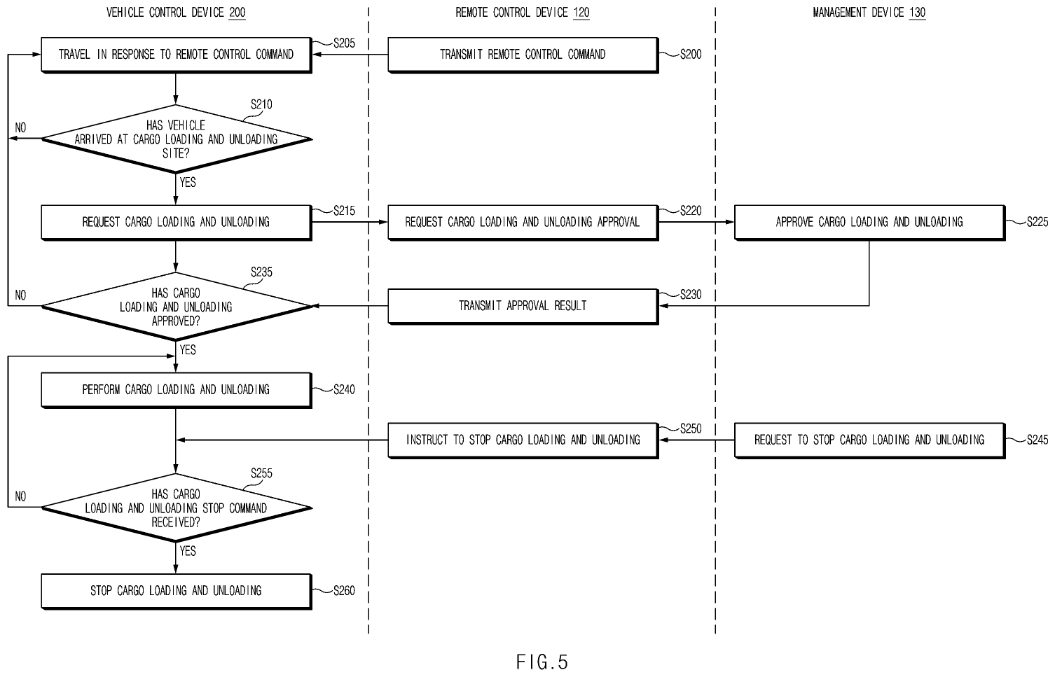

FIG. 5 is a flowchart illustrating a vehicle remote control method according to various exemplary embodiments of the present invention. The exemplary embodiment will be described with an example in which the vehicle 110 performs the cargo loading and unloading work in a response to instructions of the remote control device 120 in the remote control mode.

The remote control device 120 may transmit a remote control command to the vehicle control device 200 after activating the remote control function (S200). The remote control device 120 may transmit location information of the work location, for example, the cargo loading and unloading site, to the vehicle 110. The remote control device 120 may instruct the vehicle 110 to move to the work location together with the work location information transmission.

The vehicle control device 200 may control the travel of the vehicle 110 in a response to the remote control command (S205). The vehicle control device 200 may control the travel of the vehicle 110 to the work location, for example, the cargo loading and unloading site, in a response to the control command transmitted from the remote control device 120.

The vehicle control device 200 may determine whether the vehicle has arrived at the cargo loading and unloading site (S210). The vehicle control device 200 may compare the location of the vehicle location acquired by the positioning device 230 with the location of the cargo loading and unloading site to determine whether the vehicle 110 has arrived at the cargo loading and unloading site (the work location).

The vehicle control device 200 may send a request to the remote control device 120 for the cargo loading and unloading permission when the vehicle 110 arrives at the cargo loading and unloading site (S215). For example, the vehicle control device 200 may send a request to the remote control device 120 for permission to unload cargo loaded in the dump body when the vehicle 110 arrives at a cargo unloading site.

The remote control device 120 may send a request to the management device 130 for the cargo loading and unloading approval of the vehicle 110 (S225). The remote control device 120 may transmit a cargo loading and unloading approval request message requesting the permission for the cargo loading and unloading to the management device 130 in a response to the request of the vehicle 110.

The management device 130 may approve the cargo loading and unloading in a response to the request of the remote control device 120 (S225). The management device 130 may transmit a response message for approving (permitting) the cargo loading and unloading to the remote control device 120.

The remote control device 120 may transmit an approval result indicating that the cargo loading and unloading has been approved by the management device 130 to the vehicle control device 200 (S230).

The vehicle control device 200 may determine whether the cargo loading and unloading is approved based on the approval result transmitted from the remote control device 120 (S235).

When the cargo loading and unloading is approved, the vehicle control device 200 may perform the cargo loading and unloading of the vehicle 110 (S240). The vehicle control device 200 may control the hydraulic device of the vehicle 110 to perform the cargo loading and unloading work. For example, when the unloading of the load is approved, the vehicle control device 200 may control the hydraulic device to perform a dump body dumping work of the vehicle 110.

The management device 130 may request the remote control device 120 to stop the cargo loading and unloading while the vehicle 110 is performing the cargo loading and unloading (S245). The manager may request to stop the work when the dangerous situation occurs by monitoring the state of the vehicle 110.

The remote control device 120 may instruct the vehicle control device 200 to stop the cargo loading and unloading in a response to the request of the management device 130 (S250).

The vehicle control device 200 may determine whether a control command instructing to stop the cargo loading and unloading is received from the remote control device 120 (S255).

The vehicle control device 200 may stop the cargo loading and unloading work of the vehicle 110 when receiving the control command instructing to stop the cargo loading and unloading (S260). The vehicle control device 200 may stop the cargo loading and unloading work of the vehicle 110 when receiving the work stop command from the remote control device 120.

Furthermore, the vehicle control device 200 may terminate the cargo loading and unloading work of the vehicle 110 when the cargo loading and unloading of the vehicle 110 is completed.

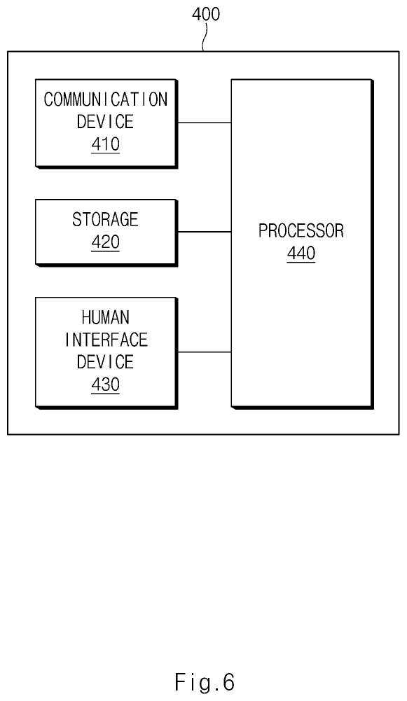

FIG. 6 is a block diagram illustrating a computing system according to exemplary embodiments of the present invention.

A computing system 400 may be implemented with the remote control device 120 and/or the management device 130. The computing system 400 may include a communication device 410, storage 420, a human interface device (HID) 430, a processor 440, and the like.

The communication device 410 may support wired and/or wireless communication between the vehicle 110 and the remote control device 120 or between the remote control device 120 and the management device 130. The communication device 410 may include a wireless communication circuit (e.g., a cellular communication circuit, a short-range wireless communication circuit, or a global navigation satellite system (GNSS) communication circuit) or a wired communication circuit (e.g., a local area network (LAN) communication circuit or a power line communication circuit), and may communicate, using a corresponding communication circuit therefrom, with the external device through a short-range communication network such as a Bluetooth, a WiFi direct, or an infrared data association (IrDA), or a telecommunication network such as a cellular network, an Internet, or a computer network. The above-described various types of communication circuits may be implemented as a single chip or as separate chips.

The storage 420 may be a non-transitory storage medium that stores instructions. The storage 420 may store a program for the operation of the remote control device 120, a program for the operation of the management device 130, and/or input data and/or output data of the processor 440. The storage 420 may be implemented as at least one of storage media of a flash memory, a RAM, a ROM, an EPROM, an EEPROM, a register, a hard disk, a removable disk, and/or web storage.

The human interface device 430 may generate data resulted from manipulation of the user. Furthermore, the human interface device 430 may output visual information, auditory information, and/or tactile information under control of the processor 440.

The human interface device 430 may include an input device such as a keyboard, a keypad, a button, a switch, a touch pad, and/or a touch screen, and/or an output device such as a display, a speaker, and/or a haptic module.

The processor 440 may be a semiconductor device that executes processing on instructions stored in the storage 420. The processor 440 may be implemented as at least one of processing devices of an application specific integrated circuit (ASIC), a digital signal processor (DSP), a programmable logic device (PLD), a field programmable gate array (FPGA), a central processing unit (CPU), a microcontroller, and/or a microprocessor.

The description above is merely illustrative of the technical idea of the present invention, and various modifications and changes may be made by those skilled in the art without departing from the essential characteristics of the present invention. Therefore, the exemplary embodiments disclosed in various exemplary embodiments of the present invention are not intended to limit the technical idea of the present invention but to illustrate the present invention, and the scope of the technical idea of the present invention is not limited by the embodiments. The scope of the present invention should be construed as being covered by the scope of the appended claims, and all technical ideas falling within the scope of the claims should be construed as being included in the scope of the present invention.

According to various exemplary embodiments of the present invention, when the vehicle arrives at the construction site, the vehicle is controlled remotely and precisely, so that it is possible to prevent a rollover accident which may occur in a process of unloading the vehicle load in advance.

Furthermore, according to various exemplary embodiments of the present invention, because the loading and unloading process of the load, which requires an improvised response at the construction site, is performed through the remote control, work efficiency may be increased.

Furthermore, according to various exemplary embodiments of the present invention, as goods transportation is performed through the autonomous driving of the vehicle, day and night continuous work is possible, which has an economic effect.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for remotely controlling a vehicle, the system comprising:
the vehicle including a vehicle control device; and
a remote control device configured to perform data communication with the vehicle control device of the vehicle,
wherein the vehicle control device of the vehicle is configured to:
send a request to the remote control device for remote control of the vehicle when the vehicle arrives at a destination thereof;
move the vehicle to a work location for the vehicle to perform work under control of the remote control device;
request the remote control device to deactivate the remote control when the work is completed; and
perform exiting of the vehicle from the destination through autonomous driving of the vehicle.

2. The system of claim 1, wherein the vehicle is a construction vehicle or a distribution vehicle.

3. The system of claim 1, wherein the remote control device is configured to activate a remote control function of the vehicle in a response to the request to the remote control of the vehicle.

4. The system of claim 1, wherein the vehicle control device of the vehicle is configured to:
switch a control mode of the vehicle from an autonomous control mode to a remote control mode; and
display state information indicating that the vehicle is operating in the remote control mode on a front surface of the vehicle.

5. The system of claim 4,
wherein the vehicle control device of the vehicle is configured to send a request to the remote control device for entry to the destination in the remote control mode, and
wherein the remote control device is configured to send a request to a management device for approval to the entry to the destination in a response to the request of the vehicle control device.

6. The system of claim 5, wherein the management device is configured to determine to approve or reject the entry to the destination of the vehicle according to the state information displayed on the front surface of the vehicle.

7. The system of claim 1, wherein the vehicle control device of the vehicle is configured to:
send a request to the remote control device for work approval when the vehicle arrives at the work location; and
control a hydraulic device of the vehicle to perform the work when receiving the work approval from the remote control device.

8. The system of claim 7, wherein the vehicle control device of the vehicle is configured to stop the work when receiving a work stop command from the remote control device while performing the work.

9. The system of claim 1,
wherein the vehicle control device of the vehicle is configured to send a request to the remote control device for remote control deactivation when the vehicle arrives at a destination exit location, and
wherein the remote control device is configured to deactivate a remote control function of the vehicle in a response to the request of the remote control deactivation.

10. The system of claim 9, wherein the vehicle control device of the vehicle is configured to:
switch a control mode from a remote control mode of the vehicle to an autonomous control mode when the remote control function is deactivated;
send a request to the remote control device for destination exit; and
exit the destination in the autonomous control mode when receiving an approval to the destination exit from the remote control device.

11. A method remotely controlling a vehicle, the method including:
sending, by a vehicle control device of the vehicle, a request to a remote control device for remote control of the vehicle after arriving at a destination thereof;
performing, by the vehicle control device, work after moving the vehicle to a work location under control of the remote control device;
requesting, by the vehicle control device, the remote control device to deactivate the remote control when the work is completed; and
performing, by the vehicle control device, exit of the vehicle from the destination through autonomous driving of the vehicle.

12. The method of claim 11, wherein the sending the request to the remote control includes:
switching a control mode of the vehicle from an autonomous control mode to a remote control mode when the vehicle arrives at the destination; and
activating, by the remote control device, a remote control function of the vehicle in a response to the request to the remote control of the vehicle.

13. The method of claim 12, wherein the sending the request to the remote control further includes:
displaying, by the vehicle control device, state information indicating that the vehicle is operating in the remote control mode on a front surface of the vehicle.

14. The method of claim 13, wherein the sending the request to the remote control further includes:
sending, by the vehicle control device, a request to the remote control device for destination entry;
sending, by the remote control device, a request to a management device for destination entry approval; and
transmitting, by the remote control device, an entry approval response of the management device to the vehicle.

15. The method of claim 14, wherein the sending the request to the remote control further includes:
determining, by the management device, to approve or reject the destination entry according to the state information displayed on the front surface of the vehicle.

16. The method of claim 11, wherein the performing of the work includes:
performing, by the vehicle control device, the moving of the vehicle to the work location provided from the remote control device;
sending, by the vehicle control device, a request to the remote control device for work approval when the vehicle arrives at the work location; and
controlling, by the vehicle control device, a hydraulic device of the vehicle to perform the work based on a result of the work approval received from the remote control device.

17. The method of claim 11, further including:
receiving, by the vehicle control device, a work stop command from the remote control device while performing the work; and
stopping, by the vehicle control device, the work in a response to the work stop command.

18. The method of claim 11, wherein the requesting to deactivate the remote control includes:
deactivating, by the remote control device, a remote control function of the vehicle in a response to the request of the vehicle control device; and
switching, by the vehicle control device, a control mode from a remote control mode to an autonomous control mode.

19. The method of claim 18, wherein the performing of the exit of the vehicle from the destination includes:
sending, by the vehicle control device, a request to the remote control device for the exit from the destination; and
exiting the destination in the autonomous control mode when receiving an approval of the exit from the destination from the remote control device.
